(19) United States
(12) Patent Application Publication
(10) Pub. No.: US 2025/0177940 A1
(43) Pub. Date: Jun. 5, 2025

(54) APPARATUS AND METHOD FOR CONTROLLING CATALYST TEMPERATURE WITHIN A REACTOR TUBE

(71) Applicant: Air Liquide Large Industries U.S. LP, Houston, TX (US)

(72) Inventor: Gary D. MILLER, Houston, TX (US)

(21) Appl. No.: 18/529,914

(22) Filed: Dec. 5, 2023

(51) Int. Cl. B01J 8/06; B01J 8/00; C01B 3/38

(52) U.S. Cl. CPC B01J 8/067; B01J 8/001; B01J 8/0015; B01J 8/065; C01B 3/38; B01J 2208/00061; B01J 2208/00398; B01J 2208/00752; C01B 2203/0233; C01B 2203/085; C01B 2203/1017; C01B 2203/1241

(57) ABSTRACT

A method and apparatus for adjusting the temperature inside a reformer tube is provided. This includes utilizing at least one heating element. The heating element is inserted inside the reformer tube and is located approximately at the axial center of the reformer tube. The reformer tube is then filled with catalyst, thereby maintaining the central location of the heating element. The heat input of the heating element may now be adjusted, thereby controlling the temperature of the catalyst.

### BACKGROUND

During normal operation of a tube-type reformer (such as a steam methane reformer or SMR), a portion of one or more catalyst tubes may experience unexpectedly low local temperatures. Therefore, typically the overall burner power must then be increased, and/or the steam to carbon ratio must be reduced in order to bring the temperature up. However, these methods globally affect overall plant efficiency. Therefore, there is a need in the industry for a method for better controlling the temperature in SMR tubes.

### SUMMARY

A method and apparatus for adjusting the temperature inside a reformer tube is provided. This includes utilizing at least one heating element. The heating element is inserted inside the reformer tube and is located approximately at the axial center of the reformer tube. The reformer tube is then filled with catalyst, thereby maintaining the central location of the heating element. The heat input of the heating element may now be adjusted, thereby controlling the temperature of the catalyst.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a cross-sectional view of a reactor tube, a single heating element, and a centering ring, in accordance with one embodiment of the present invention.

FIG. 2 is a schematic representation of a cross-sectional view of a reactor tube, multiple heating elements, and a centering ring, in accordance with one embodiment of the present invention.

FIG. 3 is a schematic representation of an isometric view of a single heating element and centering ring located in a reactor tube, in accordance with one embodiment of the present invention.

FIG. 4 is a schematic representation of an isometric view of a single heating element and centering ring located in a reactor tube that is partially filled with catalyst, in accordance with one embodiment of the present invention.

FIG. 5 is a schematic representation of an isometric view of multiple heating elements and centering ring located in a reactor tube, in accordance with one embodiment of the present invention.

FIG. 6 is a schematic representation of an isometric view of multiple heating elements and centering ring located in a reactor tube that is partially filled with catalyst, in accordance with one embodiment of the present invention.

FIG. 7 is a schematic representation of an isometric view of multiple heating elements and centering ring located in a reactor tube that is intermediately filled with catalyst, in accordance with one embodiment of the present invention.

FIG. 8 is a schematic representation of an isometric view of multiple heating elements and centering ring located in a reactor tube that is almost fully filled with catalyst, in accordance with one embodiment of the present invention.

FIG. 9 is a schematic representation of a cross-sectional view of a heating element illustrating the internal heat source and varying wall thickness, in accordance with one embodiment of the present invention.

FIG. 10 is a schematic representation of a cross-sectional view of a heating element illustrating a heat moderating jacket, in accordance with one embodiment of the present invention.

FIG. 11 is a schematic representation of a cross-sectional view of a heating element illustrating the heat source inlet and heat source outlet, in accordance with one embodiment of the present invention.

### ELEMENT NUMBERS

101=steam methane reformer tube
103=centering ring
105=catalyst
106=heating element
106a=first heating element
106b=second heating element
106c=third heating element
106d=fourth heating element
113=bottom (distal end) of the reactor tube
114=top (proximal end) of the reactor tube
115=outside diameter of heating element
116=inside diameter of heating element
117=heat source for heating element
118=heat moderating jacket
119=moderating heat transfer fluid
120=heat source inlet
121=heat source outlet

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Details of the design and operation of the reactor tube filling, at least, are as described in U.S. Pat. Nos. 11,253,830; 11,517,867; 11,534,731; and 11,541,366; the relevant part which is incorporated herein by reference.

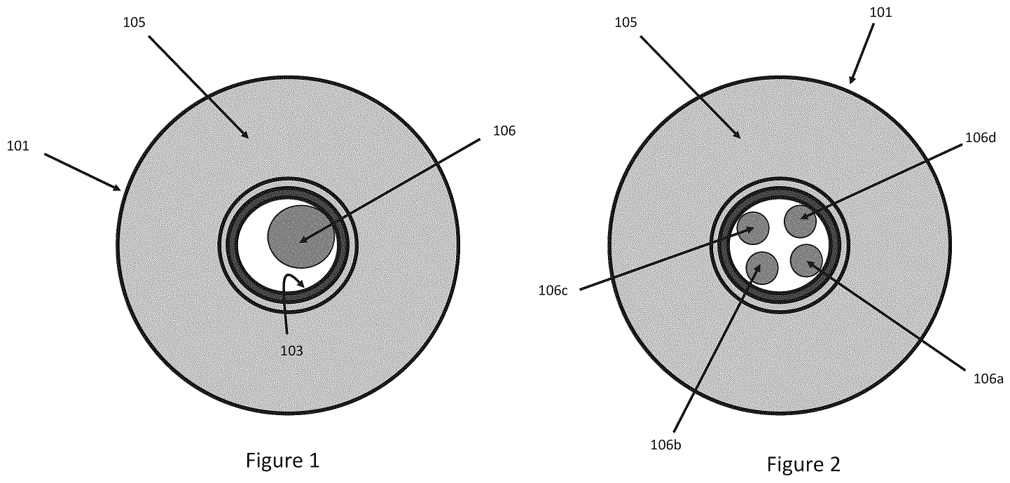

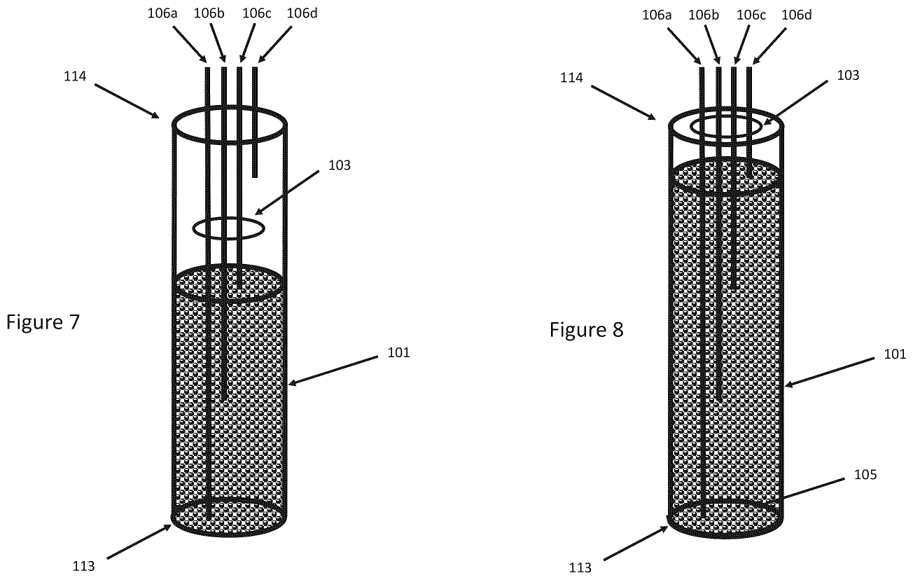

In reference to FIGS. 1-11, as an overview, an apparatus and method for inserting and utilizing a heating element in a reformer tube is provided. A centering ring is centered within an empty reformer tube. Then using a method or apparatus in the incorporated references, the reformer tube is filled with catalyst, and the heating element is approximately centered in the reformer tube and held in place by the catalyst. In markets where carbon dioxide emissions come with credits or costs, this may be valuable to the operator.

A reaction such as would be within a steam methane reformer is endothermic. Thus, if heat is applied from inside the catalyst filled tube, the heat output of the burners into the furnace region can be reduced. This allows the carbon dioxide production from the furnace at the flue to be reduced.

Heating element 106 will allow the user to increase the bulk temperature of the reactor tube 101 along the entire length. In another embodiment, two or more heating elements 106a/106d may be inserted into reactor tube 101. Heating element 106a, for example, may be designed to affect the temperature of the entire length of catalyst, while heating element 106d may be designed to affect the temperature of only an inlet portion of the catalyst. In the non-limiting example of multiple heating elements, four heating elements are illustrated, but the skilled artisan will decide the particular number and placement for his particular application.

The skilled artisan will recognize the value in the above ability to control internal tube temperature. In the current state-of-the-art each reformer tube is functionally operated as a plug flow reactor. The reactor tube internal temperature cannot be controlled, except in a very gross way by modulating the temperature of the entire furnace. One skilled in the art will recognize that the above will effectively tailor the reaction. This scheme also effectively allows the furnace to run at a given conversion but at a cooler temperature, thereby potentially extending equipment life.

FIG. 1 and FIG. 2 represent a cross-sectional view of reactor tube 101 utilizing the instant apparatus and method. Reactor tube 101 may be a steam methane reformer tube. As illustrated in FIG. 1, the SMR tube, is filled with catalyst 105, and contains centering ring 103. Within centering ring 103 is at least one heating element 106. Heating element 106 is located inside of centering ring 103, and after installation is also positioned near the axial center of reactor tube 101.

In another embodiment, as illustrated in FIG. 2, multiple heating elements 106a-106d are presented. As discussed above, this allows the operator to heat or adjust the tube temperature as required.

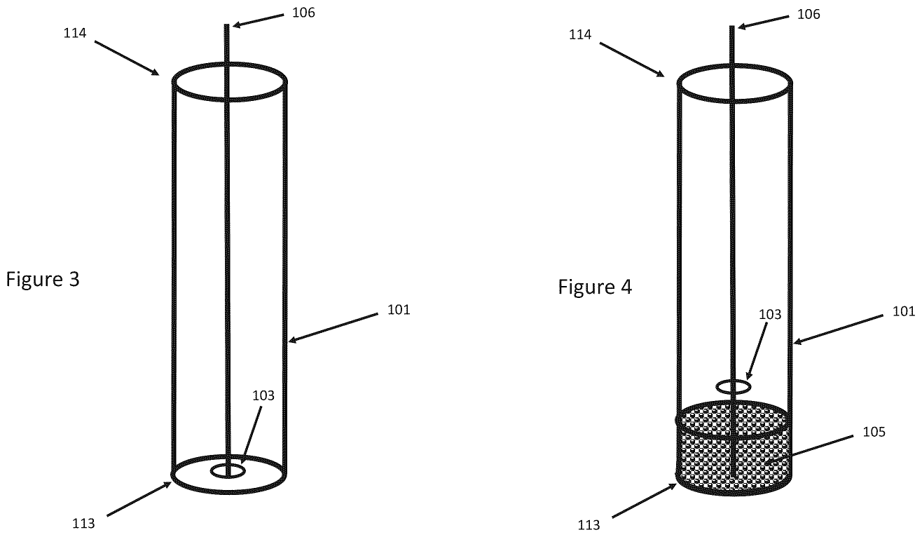

FIG. 3 and FIG. 4 represent the basic installation method for a single heating element 106. Starting at proximal end 114, heating element 106 is inserted down the length of empty reactor tube 101, until it is near distil end 113. As reactor tube 101 is filled with catalyst 105, as described in the incorporated patents, centering ring 103 is raised, keeping heating element 106 approximately centered in reactor tube 101.

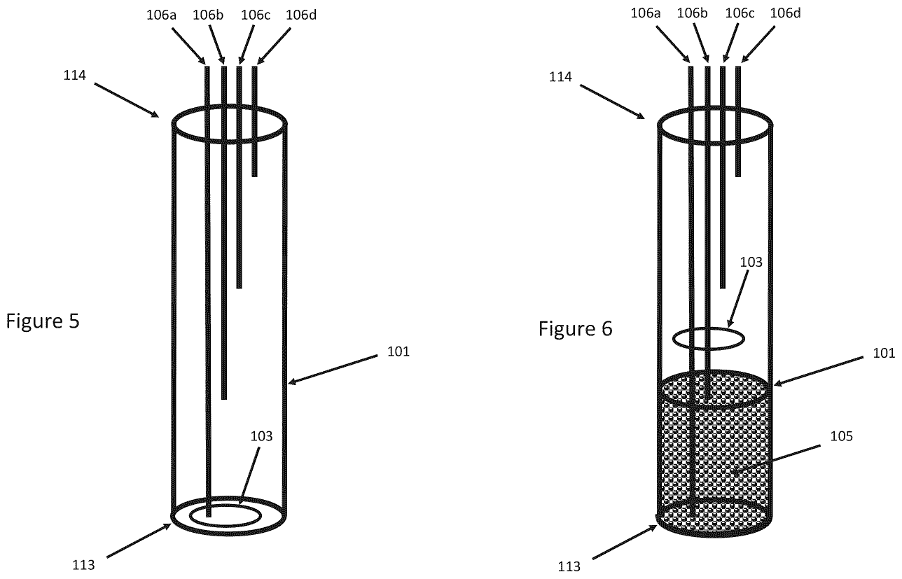

FIG. 5 and FIG. 6 represent the basic installation method for multiple heating elements 106a-106d. Starting at proximal end 114, heating element 106a is inserted down the length of empty reactor tube 101, until it is near distil end 113. Heating element 106b is then inserted down the length of reactor tube 101 to the desired location (herein shown to be approximately ¾ of the tube length). Heating element 106c is then inserted down the length of reactor tube 101 to the desired location (herein shown to be approximately ½ of the tube length).

Heating element 106d is then inserted down the length of reactor tube 101 to the desired location (herein shown to be approximately ¼ of the tube length). The skilled artisan will recognize that these heating elements may be inserted simultaneously or separately. And, as stated above, the skilled artisan will decide the particular number and placement for his particular application. The skilled artisan will recognize that the greatest impact, and thus value, will be from heat element 106d, which adds heat at the tube entry, where the temperature difference between the reactants and the bulk temperature of the furnace will be the greatest. The least impact, and thus value, will be from element 106a, which is at the tube exit, where the temperatures are closer to equilibrium.

As reactor tube 101 is filled with catalyst 105, as described in the incorporated patents, centering ring 103 is raised, keeping heating element 106a approximately centered in reactor tube 101, then consecutively heating elements 106b-d, covered with catalyst and centered.

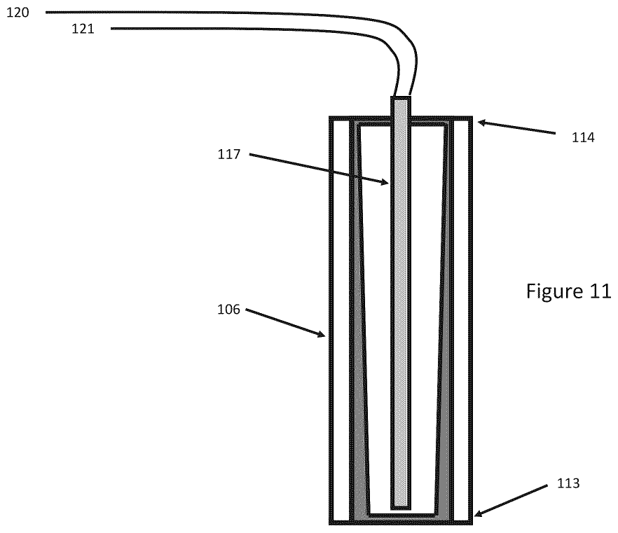

As illustrated in FIG. 11, in one embodiment, Heat source inlet 120 and heat source outlet 121 for heating elements 106 provide a circulating heat transfer fluid. In a preferred embodiment, Heat source inlet 120 and heat source outlet 121 for heating elements 106 operate by electrical resistance. If heating elements 106 are heated electrically, the electrical supplier may provide green power, thereby further reducing the net carbon dioxide emissions.

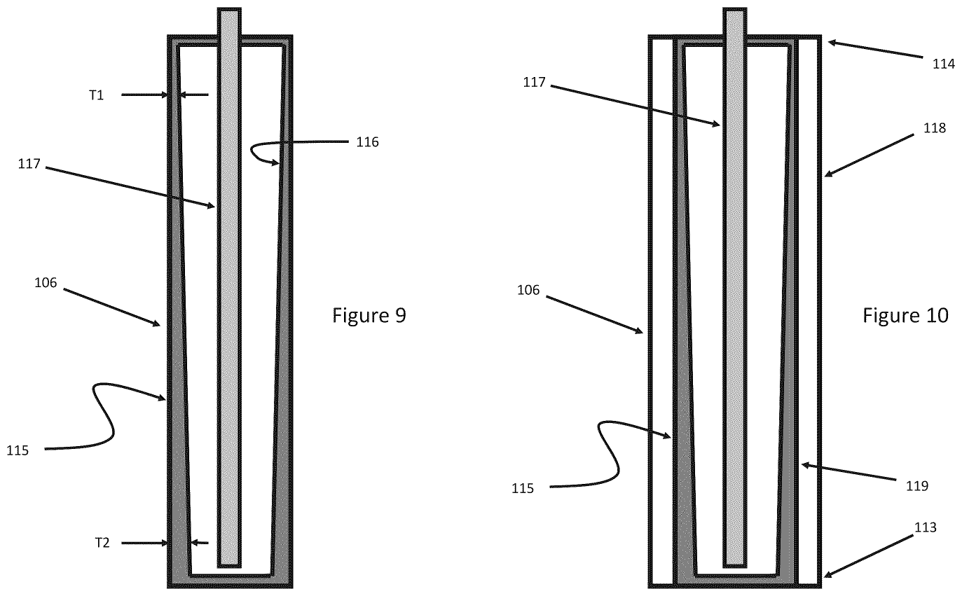

As illustrated in FIG. 9, in one embodiment, the wall thickness T1/T2 of heating element 106 may be varied, thereby fine tuning the application of heat to the needs of the relevant section of reactor tube 101. In one non-limiting example, the thickness T1 at proximal end 114 is thinner, thereby transferring greater heat into the inlet end of reactor tube 101. In this example, the thickness T2 at distil end 113 is greater, thereby transferring less heat to the exit end of reactor tube 101.

As illustrated in FIG. 10, in one embodiment, heat moderating jacket 118 may be placed around heating element 106. Heat moderating jacket 118 may have an interior space 119, which may be filled with either static or circulating moderating heat transfer fluid. Heat moderating jacket 118 will help prevent heating element 106 from becoming too hot and thus cracking the feedstock and potentially plating heating element 106 with carbon.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A device for adjusting the temperature inside a reformer tube, comprising:
at least one heating element,
the at least one heating element is located inside the reformer tube,
wherein the at least one heating element is located approximately at the axial center of the reformer tube, and
the reformer tube is filled with catalyst, thereby maintaining the location of the at least one heating element.

2. The device of claim 1, comprising a single heating element.

3. The device of claim 1, comprising two heating elements.

4. The device of claim 1, comprising more than two heating elements.

5. The device of claim 1, wherein the at least one heating element comprises an electrical heat source.

6. The device of claim 1, wherein the at least one heating element comprises an outer wall with a wall thickness and a length, wherein the wall thickness varies along the length.

7. The device of claim 1, wherein the at least one heating element further comprises a heat moderating jacket.

8. A method for adjusting the temperature inside a reformer tube, comprising:
providing at least one heating element,
inserting the at least one heating element inside the reformer tube,
wherein the at least one heating element is located approximately at the axial center of the reformer tube, and
filling the reformer tube with catalyst, thereby maintaining the location of the at least one heating element,
adjusting the heat input rate of the at least one heating element thereby controlling the temperature of the catalyst.

9. The method of claim 8, comprising a single heating element.

10. The method of claim 8, comprising two heating elements.

11. The method of claim 8, comprising more than two heating elements.

12. The method of claim 8, wherein the at least one heating element comprises an electrical heat source.

13. The method of claim 8, wherein the at least one heating element comprises an outer wall with a wall thickness and a length, wherein the wall thickness varies along the length.

14. The method of claim 8, wherein the at least one heating element further comprises a heat moderating jacket.
